(19) United States
(12) Patent Application Publication
(10) Pub. No.: US 2003/0136384 A1
(43) Pub. Date: Jul. 24, 2003

(54) Fuel injection system for an internal combustion engine

(76) Inventors: Dietmar Van Der Linden, Rietenau (DE); Achim Koehler, Ditzingen (DE); Sascha Ambrock, Gerlingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/319,584

(22) Filed: Dec. 16, 2002

(30) Foreign Application Priority Data
Dec. 19, 2001 (DE) 1 01 62 385.2

(51) Int. Cl. F02M 41/00

(52) U.S. Cl. 123/458; 123/446

(57) ABSTRACT

A fuel injection system has a feed pump by which fuel is supplied to a high-pressure pump which pumps fuel into a reservoir as a function of engine operating parameters. The system has a fuel metering device for adjusting the fuel quantity pumped by the high-pressure pump, the metering device having an actuator controlling a regulating valve having a slide-shaped valve member guided in a cylindrical bore of a valve housing and displaceable by the actuator counter to a restoring force. An outer jacket of the valve member in cooperation with an outlet from the cylindrical bore controls a flow cross section from the feed pump to the high-pressure pump. The valve member controlls an inlet opening, originating at the feed pump and discharging into the cylindrical bore, and in one position closes the inlet opening completely.

### BACKGROUND OF THE INVENTION

1. Field of the Invention

The invention is directed to an improved fuel injection system for an internal combustion engine.

2. Description of the Prior Art

One fuel injection system known from German Patent Disclosure DE 198 53 103 A1 has a feed pump by which fuel is pumped to a high-pressure pump, and the high-pressure pump pumps the fuel at high pressure into a reservoir. A fuel metering device is also provided, which is disposed between the feed pump and the high-pressure pump. The fuel metering device serves to control the quantity of fuel, pumped by the high-pressure pump into the reservoir, as a function of engine operating parameters. The fuel metering device includes an actuator in the form of an electromagnet and a regulating valve that is actuated by this actuator and that has a slide-shaped valve member, guided in a cylindrical bore of a valve housing, the valve member being movable by an armature of the electromagnet counter to a restoring spring. In cooperation with an outlet opening of the valve housing, and via its outer jacket, the valve member controls a flow cross section from the feed pump to the high-pressure pump as a function of the stroke. In a closing position of the valve member, the valve member has its outer jacket in coincidence with the outlet opening, so that the flow cross section is closed completely. However, since the valve member must be displaceable in the cylindrical bore of the valve housing, there is a slight gap between its outer jacket and the cylindrical bore, through which a leakage quantity of fuel can pass and reach the high-pressure pump through the outlet opening, even if no fuel needs to be pumped by the high-pressure pump because of the engine operating parameters, such as in the overrunning mode. Provisions are therefore necessary for carrying this leakage quantity of fuel away so that it can no longer reach the high-pressure pump. This makes the structure and production of the fuel injection system complicated and expensive.

### OBJECT AND SUMMARY OF THE INVENTION

The fuel injection system of the invention has the advantage over the prior art that by means of the valve member and specifically its sealing face in cooperation with the valve seat, the high-pressure pump can be disconnected completely from the feed pump; thus no further provisions are necessary to accomplish this, and the structure and production of the fuel injection system are simplified accordingly.

Other advantageous features and refinements of the fuel injection system of the invention are disclosed. By means of one embodiment, via the outer jacket of the valve member, a separation is achieved between the functions of the complete sealing, by means of the sealing face, and of the control of the size of the flow cross section. By means of another feature, a secure seal is made possible by means of the sealing face of the valve member, in cooperation with the valve seat.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically shows a fuel injection system for an internal combustion engine in accordance with the invention;

FIG. 2 is an enlarged view of a fuel metering device of the fuel injection system in a first exemplary embodiment, and in a first position;

FIG. 3 shows the fuel metering device in a second position;

FIG. 4 shows the fuel metering device in a view in the direction of the arrow IV in FIG. 2; and

FIG. 5 shows the fuel metering device in a second exemplary embodiment.

### DESCRIPTION OF THE PREFERRED EMBODIMENTS

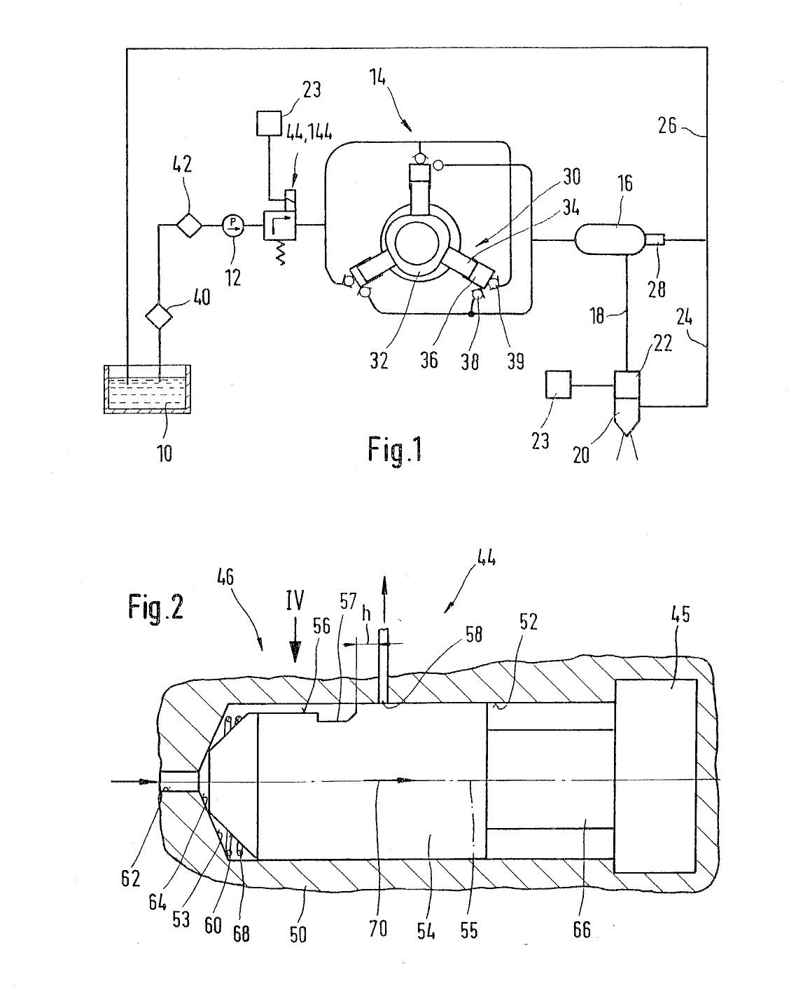

In FIG. 1, a fuel injection system for an internal combustion engine, for instance of a motor vehicle, is shown. The engine is preferably a self-igniting internal combustion engine and has one or more cylinders. The motor vehicle has a fuel tank 10, in which fuel for operating the engine is kept on hand. The fuel injection system has a feed pump 12, by which fuel is pumped out of the fuel tank 10 to a high-pressure pump 14. The high-pressure pump 14 pumps fuel into a reservoir 16, which can for instance be tubular or can be embodied in some arbitrary other shape. From the reservoir 16, lines 18 lead to injectors 20, disposed one at each cylinder of the engine. One electronic control valve 22 is disposed at each of the injectors 20 and by way of it, opening of the injectors is controlled so as to effect a fuel injection through the applicable injector 20 or to prevent a fuel injection. The control valves are triggered by an electronic control unit 23, by which the instant and duration of the fuel injection through the injectors 20 is determined as a function of engine operating parameters, such as rpm, load, temperature, and others. From the injectors 20, a return for unused fuel leads at least indirectly, for instance via one line 24 common to all the injectors, back into the fuel tank 10. From the reservoir 16, a line 26 can also lead to the fuel tank 10, in which line a pressure limiting valve 28 is disposed in order to prevent an impermissibly high pressure from building up in the reservoir 16.

The high-pressure pump 14 is driven mechanically by the engine and thus in proportion to the engine rpm. The feed pump 12 can also be driven mechanically by the engine, and a common driveshaft can be provided for both the high-pressure pump 14 and the feed pump 12. Alternatively, the feed pump 12 can have an electric-motor drive mechanism, for instance.

The feed pump 14 can be embodied as a radial piston pump and has a plurality of pump elements 30, for instance three of them, spaced apart at equal angular intervals from one another, which each have one pump piston 34, driven to reciprocate by a polygon 32 together with an eccentric shaft, and each pump piston defines one pump work chamber 36. In each of the connections between the pump work chambers 36 and the reservoir 16 there is a respective check valve 38, which opens toward the reservoir 16 and by which the disconnection between the pump work chambers 36 and the reservoir 16 is effected in the intake stroke of the pump pistons 34. In each of the connections between the pump work chambers 36 and the feed pump 12 there is a respective check valve 39, which opens toward the pump work chambers 36 and by which the separation or disconnection between the pump work chambers 36 and the feed pump 12 is effected upon the pumping stroke of the pump pistons 34. During a given intake stroke of the pump pistons 34, when they are moving radially inward, the pump work chambers 36, with the check valves 39 open, communicate with the outlet of the feed pump 12 and are filled with fuel, the pump work chambers 36 being disconnected from the reservoir 16 by the closed check valves 38. During a given pumping stroke of the pump pistons 34, when they are moving radially outward, the pump work chambers 36, with the check valves 38 open, communicate with the reservoir and are disconnected from the outlet of the feed pump 12 by the closed check valves 39.

One or more filters are preferably disposed between the feed pump 12 and the fuel tank 10. For instance, beginning at the fuel tank 10, first a coarse filter 40 and downstream of it then a fine filter 42 may be provided; the fine filter 42 can additionally have a water separator.

A fuel metering device 44 is disposed between the feed pump 12 and the high-pressure pump 14. The fuel metering device 44 has a regulating valve 46, actuated by an electric actuator 45, such as an electromagnet or a piezoelectric actuator, and the flow from the feed pump 12 to the high-pressure pump 14 is continuously adjustable by this regulating valve 46. The fuel metering device 44 is also triggered by the control unit 23, in such a way that by means of the feed pump 12, a quantity of fuel is delivered to the high-pressure pump 14 that is then in turn pumped at high pressure into the reservoir 16 by the high-pressure pump 14, so that a predetermined pressure, dependent on engine operating parameters, can be maintained in the reservoir 16.

In FIGS. 2-4, the fuel metering device 44 is shown enlarged in a first exemplary embodiment. The fuel metering device 44 has, as part of the regulating valve 46, a valve housing 50, in which a slide-shaped valve member 54 is guided displaceably in a cylindrical bore 52. In its outer jacket, the valve member 54 has at least one recess 56, which extends in the direction of the longitudinal axis 55 of the valve member 54 over a portion of the length and also extends over a portion of the circumference of the valve member 54. The recess 56 will be described in still further detail hereinafter. An outlet opening 58 is embodied in the valve housing 50 and discharges into the cylindrical bore 52; the recess 56 of the valve member 54 cooperates with this outlet opening to control the size of a flow cross section. The outlet opening 58 communicates with the intake side of the high-pressure pump 14.

The recess 56 extends longitudinally along the valve member 54 as far as one face end of the valve member 54. On this face end, the valve member 54 has a sealing face 60, which for instance, as shown in FIG. 2, can be embodied as tapering at least approximately frustoconically toward one end. Alternatively, the sealing face 60 can be embodied at least approximately in the shape of a spherical segment. An inlet opening 62 which communicates with the outlet of the feed pump 12 discharges through the end wall 53 of the cylindrical bore 52 opposite the sealing face 60 of the valve member 54. Surrounding the inlet opening 62, a valve seat 64 is embodied in the valve housing 50, and the valve member 54 with its sealing face 60 cooperates with this valve seat to close the inlet opening 62. The valve seat 64 can also be embodied as at least approximately frustoconical, and the cone angles of the sealing face 60 and valve seat 64 can be either the same or different. The valve seat 64 widens toward the valve member 54. The cone angle of the valve seat 64 is preferably greater than the cone angle of the sealing face 60, so that the valve member 54 comes to rest with only the edge of its sealing face 60, at the end of the valve member 54, on the valve seat 64.

The valve member 54 is engaged, on the side remote from the valve seat 64, by an armature 66 of the electromagnet 45, and by means of this armature the valve member 54 can be displaced toward the valve seat 64 when current is supplied to the electromagnet 45. The side of the valve member 54 opposite the armature 66 is engaged by a restoring spring 68.

The function of the fuel metering device 44 will now be explained. If no fuel is to be pumped into the reservoir 16 by the high-pressure pump 14, then the electromagnet 45 is supplied, by means of the control unit 23, with a current intensity, causing the valve member 54 to be placed, counter to the force of the restoring spring 68, with its sealing face 60 in contact with the valve seat 64, as FIG. 2 shows. In this closing position, the inlet opening 62 is closed completely by the valve member 54, even if pressure is being generated by the feed pump 12. In this closing position, the recess 56 of the valve member 54 is not in coincidence with the outlet opening 58; instead, the valve member 54 has its full cylindrical cross section in coincidence with the outlet opening 58. Moreover, the end of the recess 56 is disposed with a spacing h from the edge of the outlet opening 58 in the direction of the longitudinal axis 55 of the valve member 54.

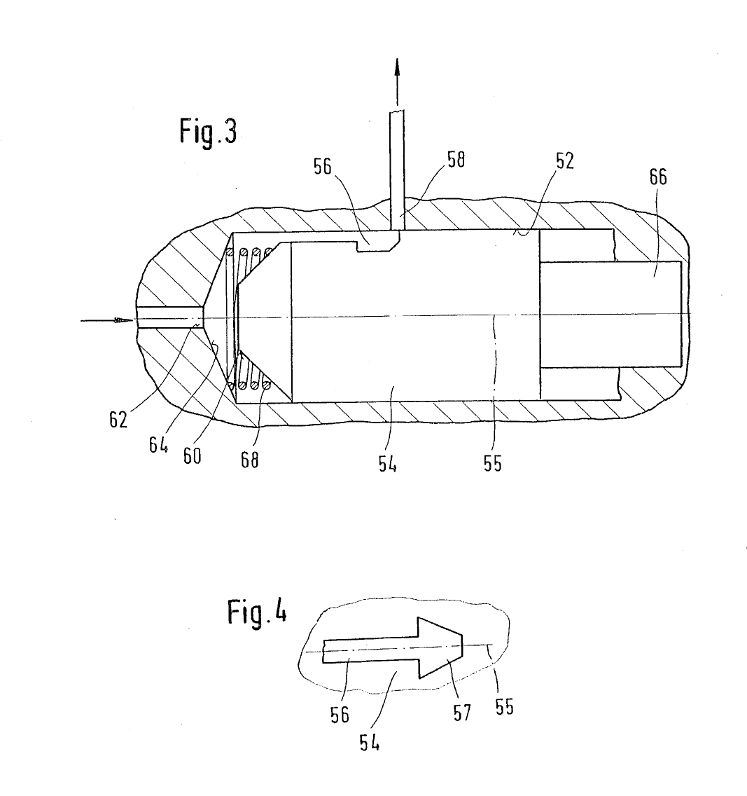

If a slight quantity of fuel is to be pumped into the reservoir 16 by the high-pressure pump 14, then by means of the control unit the electromagnet 45 is supplied with a lesser current intensity, so that the valve member 54 is moved in the opening direction 70 by the restoring spring 68 and with its sealing face 60 lifts away from the valve seat 64 and uncovers the inlet opening 62. Beginning at the closing position of the valve member 54, over an idle stroke h of the valve member 54, its recess 56 is initially not yet in coincidence with the outlet opening 58, so that as yet no flow cross section is uncovered; instead, only a slight leakage quantity of fuel can pass between the outer jacket of the valve member 54 and the cylindrical bore 52 to reach the high-pressure pump 14. Once the valve member 54 with its sealing face 60 has lifted from the valve seat 64, the space defined between the valve member 54 and the end wall 53 in the cylindrical bore 52 fills with fuel at the pressure generated by the feed pump 12. Only once the idle stroke h of the valve member 54 has been traversed does its recess 56 come to coincide with the outlet opening 58 and uncover a flow cross section, as FIG. 3 shows. As a result of this embodiment, a separation is attained between the function of complete closure of the inlet opening 62 by the valve member 54, when no fuel is to be pumped by the high-pressure pump 14, and the function of controlling the flow cross section by means of the valve member 54.

It can be provided that the recess 56 on the valve member 54 widens in such a way that by it, upon a motion of the valve member 54 in its opening direction 70, an increasingly larger flow cross section from the cylindrical bore 52 into the outlet opening 58 is uncovered. The region 57 of the recess 56 that cooperates with the outlet opening can be embodied in trapezoidal form, as shown in FIG. 4, with the region 57 widening toward the end of the valve member 54 that has the sealing face 60. Adjoining the region 57, and extending to the end of the valve member 54, the recess is embodied as a slit that is narrower than the region 57 and extends approximately parallel to the longitudinal axis 55 of the valve member 54. When the valve member 54 executes a stroke in its opening direction 70, the region 57 of the recess 56 first, with its narrow end, comes to coincide with the outlet opening 58 so that a small flow cross section is correspondingly uncovered. With an increasing stroke of the valve member 54 in its opening direction 70, the region 57 of greater width comes to coincide with the outlet opening 58, so that a correspondingly larger flow cross section is uncovered. Thus by triggering the electromagnet 45 with a different current intensity by means of the control unit 20, different flow cross sections can be controlled by the valve member 54, in order to furnish correspondingly different intake quantities for the high-pressure pump 14.

Triggering of the electromagnet 45 by the control unit 23 at different current intensities can be achieved for instance by triggering the electromagnet 45 in clocked, pulse-width-modulated fashion, with the current intensity and hence the size of the flow cross section uncovered being dependent on the pulse width. When the valve member 54 is in its closing position, as shown in FIG. 2, the intake side of the high-pressure pump 14 is disconnected completely from the feed pump 12, so that only a slight pressure prevails on the intake side of the high-pressure pump 14. The check valves 39 of the pump work chambers 36 of the high-pressure pump 14 therefore have to seal off against only a slight pressure and can therefore already open at a slight pressure. As a result only minor demands are made on the feed pump 12, and both initial starting and restarting of the engine are improved, as is the efficiency of the high-pressure pump 14, since the throttling losses at the check valves 39 are slight.

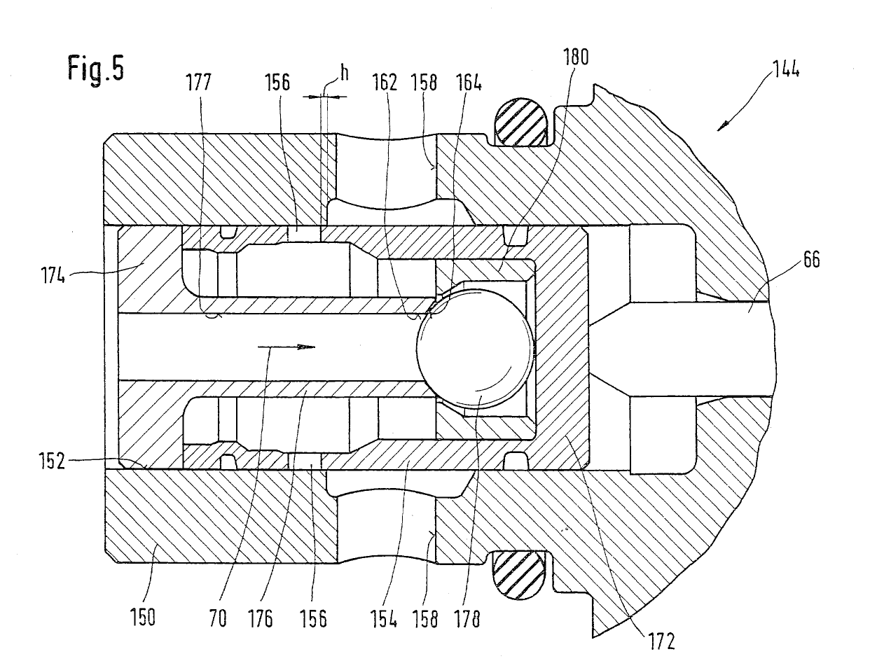

In FIG. 5, the metering device 144 is shown in a second embodiment. The metering device 144 has the valve housing 150 with the cylindrical bore 152, in which the valve member 154 is guided displaceably. The valve member 154 is cup-shaped and toward the armature 66 of the electromagnet 45, it has a closed end with a bottom 172, on which the armature 66 rests. In its jacket, the valve member 154 has at least one and preferably a plurality of openings 156 distributed over its circumference. In the valve housing 150, the at least one outlet opening 158 is embodied accordingly; preferably, a plurality of openings 158 distributed over the circumference of the valve housing 150 are provided, with which the openings 156 in the valve member 154 cooperate for controlling the size of the flow cross section. A component 174 is inserted tightly into the cylindrical bore 152 from the side remote from the electromagnet 45; this component has a connection stub 176 that protrudes into the valve member 154 from the open end thereof. A conduit 177 extends through the component 174, providing communication with the outlet of the feed pump 12, and the conduit 177 discharges into an inlet opening 162 at the end of the connection stub 176 in the valve member 154. The inlet opening 162 is surrounded by a valve seat 164 on the face end of the connection stub 176.

A separate sealing element 178 is inserted into the end region of the valve member 154, toward the bottom 172 thereof; this sealing element has a sealing face and is embodied for instance as a ball. The ball 178 can be retained in a cage 180, which is inserted and in particular press-fitted into the cylindrical bore 152. The ball 178 protrudes with part of its circumference out of the carrier 180 toward the connection stub 176. In the closing position of the valve member 154, this valve member rests with the ball 178 on the valve seat 164 on the face end of the connection stub 176 and closes the inlet opening 162. Beginning at this closing position, the openings 156 in the valve member 154 do not coincide with the outlet openings 158 in the valve housing 150 until after an idle stroke h has been traversed, as in the first exemplary embodiment, and then they control the size of the flow cross section.

The foregoing relates to preferred exemplary embodiments of the invention, it being understood that other variants and embodiments thereof are possible within the spirit and scope of the invention, the latter being defined by the appended claims.

We claim:

1. A fuel injection system for an internal combustion engine, the system comprising
a feed pump (12) by which fuel from a fuel tank (10) is supplied to the intake side of a high-pressure pump (14), and the high-pressure pump (14) pumps fuel into a reservoir (16) as a function of engine operating parameters,
a fuel metering device (44; 144) for adjusting the fuel quantity pumped into the reservoir (16) by the high-pressure pump (14),
the fuel metering device (44; 144) having an actuator (45) and a regulating valve (46) actuated by it, and the regulating valve (46) having a slide-shaped valve member (54; 154) guided in a cylindrical bore (52; 152) of a valve housing (50; 150), which valve member is displaceable by the actuator (45) counter to a restoring force (68),
the valve member (54; 154), with its outer jacket (56; 156) in cooperation with an outlet (58; 158) from the cylindrical bore (52; 152), controling a flow cross section from the feed pump (12) to the high-pressure pump (14), and
a sealing face (60; 178) on the valve member (54; 154) cooperating with a valve seat (64; 164) for controlling an inlet opening (62; 162) originating at the feed pump (12) and discharging into the cylindrical bore (52; 152) and, in a position in which it rests with its sealing face (60; 178) on the valve seat (64; 164), the valve member closing the inlet opening (62; 162) completely.

2. The fuel injection system according to claim 1, wherein the valve member (54; 154), beginning at its closing position in which it rests with its sealing face (60; 178) on the valve seat (64; 164), upon a stroke motion oriented away from the valve seat (64; 164), initially in an idle stroke (h) does not yet uncover any flow cross section with its outer jacket, and only after completing the idle stroke (h), with its outer jacket (56; 156), does it uncover an increasingly larger flow cross section as a function of the stroke.

3. The fuel injection system according to claim 1, wherein the sealing face (60) of the valve member (54) is embodied such that it tapers toward the end of the valve member (54), being at least approximately frustoconical.

4. The fuel injection system according to claim 2, wherein the sealing face (60) of the valve member (54) is embodied such that it tapers toward the end of the valve member (54), being at least approximately frustoconical.

5. The fuel injection system according to claim 1, wherein the sealing face (60) of the valve member (54) is embodied at least approximately in the form of a spherical segment.

6. The fuel injection system according to claim 2, wherein the sealing face (60) of the valve member (54) is embodied at least approximately in the form of a spherical segment.

7. The fuel injection system according to claim 1, wherein the valve seat (64; 164) is embodied as widening toward the valve member (54), preferably being at least approximately frustoconical.

8. The fuel injection system according to claim 2, wherein the valve seat (64; 164) is embodied as widening toward the valve member (54), preferably being at least approximately frustoconical.

9. The fuel injection system according to claim 3, wherein the valve seat (64; 164) is embodied as widening toward the valve member (54), preferably being at least approximately frustoconical.

10. The fuel injection system according to claim 4, wherein the valve seat (64; 164) is embodied as widening toward the valve member (54), preferably being at least approximately frustoconical.

11. The fuel injection system according to claim 1, further comprising a component (174) inserted into the cylindrical bore (152), the component having a connection stub (176) pointing toward the sealing face (178), on the end of which connection stub the valve seat (164) is embodied.

12. The fuel injection system according to claim 2, further comprising a component (174) inserted into the cylindrical bore (152), the component having a connection stub (176) pointing toward the sealing face (178), on the end of which connection stub the valve seat (164) is embodied.

13. The fuel injection system according to claim 3, further comprising a component (174) inserted into the cylindrical bore (152), the component having a connection stub (176) pointing toward the sealing face (178), on the end of which connection stub the valve seat (164) is embodied.

14. The fuel injection system according to claim 4, further comprising a component (174) inserted into the cylindrical bore (152), the component having a connection stub (176) pointing toward the sealing face (178), on the end of which connection stub the valve seat (164) is embodied.

15. The fuel injection system according to claim 5, further comprising a component (174) inserted into the cylindrical bore (152), the component having a connection stub (176) pointing toward the sealing face (178), on the end of which connection stub the valve seat (164) is embodied.

16. The fuel injection system according to claim 1, wherein the sealing face (178) is embodied on a sealing element (178) connected to the valve member (154).

17. The fuel injection system according to claim 2, wherein the sealing face (178) is embodied on a sealing element (178) connected to the valve member (154).

18. The fuel injection system according to claim 3, wherein the sealing face (178) is embodied on a sealing element (178) connected to the valve member (154).

19. The fuel injection system according to claim 4, wherein the sealing face (178) is embodied on a sealing element (178) connected to the valve member (154).

20. The fuel injection system according to claim 6, wherein the sealing face (178) is embodied in a sealing element (178) connected to the valve member (154), and wherein the valve member (154) is embodied as cup-shaped; wherein the connection stub (176) protrudes into the valve member (154) from the open side thereof; and wherein the sealing element (178) is disposed in the valve member (154) in the region of its closed end.
